(19) United States
(12) Patent Application Publication
(10) Pub. No.: US 2026/0212063 A1
(43) Pub. Date: Jul. 23, 2026

(54) DESIGN SUPPORT DEVICE, DESIGN SUPPORT PROGRAM, AND DESIGN SUPPORT METHOD

(71) Applicant: Hitachi, Ltd., Tokyo (JP)

(72) Inventor: Erika KATAYAMA, Tokyo (JP)

(21) Appl. No.: 19/142,387

(22) PCT Filed: Nov. 1, 2023
(86) PCT No.: PCT/JP2023/039427

§ 371 Date: Jun. 23, 2025

(30) Foreign Application Priority Data
Jan. 20, 2023 (JP) 2023-007185

(51) Int. Cl. G06F 30/17; G06T 7/00; G06T 7/50

(52) U.S. Cl. CPC G06F 30/17; G06T 7/0006; G06T 7/50

(57) ABSTRACT

An application range of a determination rule that can be checked on a CAD model can be expanded, and highly efficient checking can be executed. In a design support device 10 that executes a rule check using a determination rule on a CAD model 103 of an object which is a design target, the design support device 10 includes a feature value recognition unit 106 configured to recognize a 3DA feature value defined on the CAD model 103 and a shape feature value related to a shape of the object, the 3DA feature value and the shape feature value being related information of the object, and a rule checking unit 108 configured to execute the rule check based on a correlation between the 3DA feature value and the shape feature value.

### TECHNICAL FIELD

The present invention relates to a design support device, a design support program, and a design support method for supporting design of a product or the like.

### BACKGROUND ART

In the related art, products and the like are designed on a computer using a computer-aided design (CAD) system. The design using CAD is called CAD design. In CAD design, it is desirable to take into account a design guideline in consideration of manufacturability, for example, ease of processing such as drilling and bending, ease of assembly such as welding and screw fastening, and ease of plating, which are problems that arise during product manufacturing.

Further, in the CAD design, it is desirable to take into account a design guideline in consideration of maintainability such as ease of inspection and ease of access to jigs, which are problems that arise during product maintenance. The design guideline may include about several tens of thousands of rules for one product, and is usually checked manually using a check list or the like.

For example, there is a design guideline such as “a hole through which a bolt passes has a bolt diameter in a range of ◯ mm to Δ mm”. A rule that can be checked on a CAD model from a design guideline is referred to here as a determination rule.

In order to automatically check these determination rules on a CAD model (CAD design data), there is a technique of generating a program in which a plurality of functions are combined to an executable state, and notifying a designer of a violation location when a threshold set for a determination rule is not satisfied. For example, PTL 1 discloses “providing a design support system that improves checking efficiency by constructing and evolving a determination rule that can be adapted to a CAD model different from the related art”. In order to solve this problem, PTL 1 discloses “a product design support system that causes a computer to check that a CAD model of a product conforms to a guideline based on a determination rule, the computer includes a controller and a memory, and the controller functions as a geometric recognition function definition unit that sets a function for recognizing a form of a CAD model and creates a determination rule by executing a program stored in the memory, a parameter adjustment unit that adjusts a parameter based on a checking result of the CAD model and sets the parameter to the function, a rule checking unit that checks the CAD model based on the function in which the adjusted parameter is set and specifies a violation location in design, and an output unit that causes a notification device to output a checking result”.

### CITATION LIST

### Patent Literature

PTL 1: JP2022-61245A

### SUMMARY OF INVENTION

### Technical Problem

According to PTL 1, for a determination rule in which a set value of a parameter in a function or a threshold at the time of automatic checking is not clear, the parameter can be automatically searched and checked.

However, for the determination rule in PTL 1, it is possible to check a shape feature value of a CAD model, but it is difficult to check manufacturability or maintainability other than a shape. For example, in order to specify a component such as a bolt using PTL 1, a parameter is searched for from a geometric feature value such as an area, a length, or an angle or a phase feature value such as a connection relationship of surfaces or lines to estimate the component, and as a result, excessive detection or omission may occur. Since a manufacturing condition such as plating and welding are not included in shape information on 3D CAD, it is difficult to check manufacturability.

### Solution to Problem

In order to solve the above problem, the invention provides a design support device that executes a rule check using a determination rule on a CAD model of an object which is a design target. The design support device includes a feature value recognition unit configured to recognize a 3DA feature value defined on the CAD model and a shape feature value related to a shape of the object, the 3DA feature value and the shape feature value being related information of the object, and a rule checking unit configured to execute the rule check based on a correlation between the 3DA feature value and the shape feature value. The invention also provides a program for causing the design support device to function as a computer and a storage medium storing the program. Further, the invention also provides a design support method using the design support device.

### Advantageous Effects of Invention

According to the invention, an application range of a determination rule that can be checked on a CAD model can be expanded, and highly efficient checking can be performed.

### BRIEF DESCRIPTION OF DRAWINGS

FIG. 1 is a block diagram illustrating a basic configuration of a design support device according to an embodiment of the invention.

FIG. 2 is a flowchart illustrating rule checking processing according to an embodiment Of the invention.

FIG. 3 is a diagram illustrating an example in which the design support device according to the embodiment of the invention is mounted on a computer.

FIG. 4 is a diagram illustrating an example of annotations of 3DA feature values according to Embodiment 1.

FIG. 5 is a diagram illustrating an example curved surfaces and flat surfaces acquired from curvatures among shape feature values according to Embodiment 1.

FIG. 6 is a flowchart illustrating rule checking processing according to Embodiment 1.

FIG. 7 is a diagram illustrating a shape feature value and a 3DA feature value for each surface ID acquired according to Embodiment 1.

FIG. 8 is a diagram illustrating a shape and 3D feature value correlation DB according to Embodiment 1.

FIG. 9 is a CAD diagram illustrating a checking result according to Embodiment 1.

FIG. 10 is a diagram illustrating a CAD model which is a checking target according to Embodiment 2.

FIG. 11 is a flowchart illustrating rule checking processing according to Embodiment 2.

FIG. 12 is a diagram illustrating 3DA feature values of a bolt according to Embodiment 2.

FIG. 13 is a diagram illustrating a shape and 3D feature value correlation DB according to Embodiment 2.

FIG. 14 is a CAD diagram illustrating a checking result according to Embodiment 2.

FIG. 15 is a system configuration diagram according to Embodiment 3.

### DESCRIPTION OF EMBODIMENTS

Hereinafter, an embodiment according to the invention is described with reference to the drawings. In the present embodiment, in design using three-dimensional CAD (3D CAD), a rule check using a determination rule for an object is performed based on a 3DA feature value and a shape feature value of the object. As a result, it is possible to determine whether the object satisfies a design guideline. Therefore, in the present embodiment, the 3DA feature value and the shape feature value are recognized from a 3D CAD model. Here, the 3DA feature value in the present embodiment is a feature value used in a manufacturing or maintenance process for the object, and for example, at least one of an attribute which is attribute information or an annotation which is annotation information in the manufacturing or maintenance process for the object can be used.

Among them, it is possible to search for a component represented by a bolt or the like at high speed with high accuracy by utilizing the attribute. Further, it is possible to perform a rule check of manufacturability of a shape other than a 3D CAD shape, such as plating or welding by utilizing the annotation. More preferably, the 3DA feature value or the shape feature value is managed for each portion of the object. A surface or a unit solid constituting the object can be used as such a portion. In particular, a component constituting a product can be used as the unit solid. Further, the object includes various objects such as a product and a component.

The shape feature value in the present embodiment includes a geometric feature value indicating a geometric feature of an object and a phase feature value indicating a phase such as a connection relationship with an object. Examples of the geometric feature value include an area, a length, and an angle of the object. Hereinafter, a configuration in the present embodiment will be described.

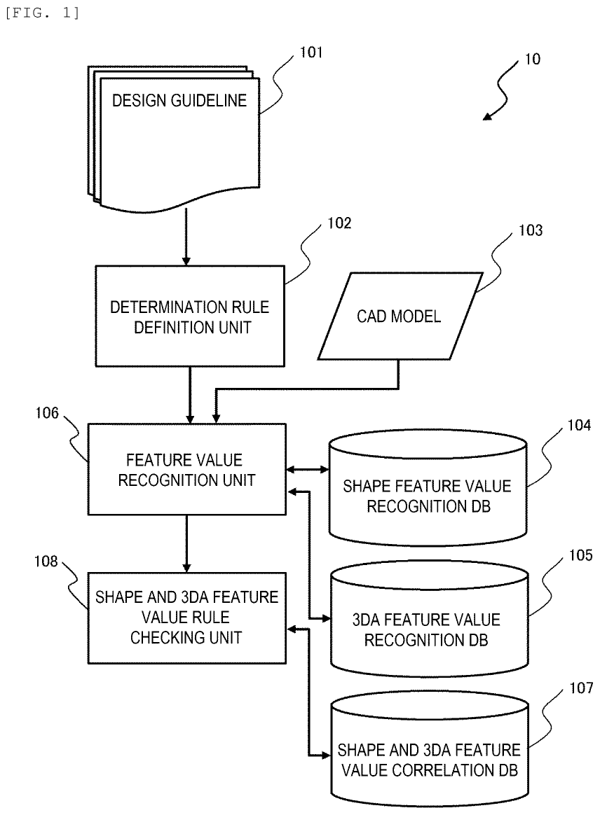

In the present embodiment, for example, a curvature r a plate thickness of a surface is used as the shape feature value, and a surface property is used as the 3DA feature value, and a rule check regarding peeling of plating is executed. In the present embodiment, a phase feature value is used. FIG. 1 is a block diagram illustrating a basic configuration of a design support device 10 according to the present embodiment. In FIG. 1, the design support device 10 includes a determination rule definition unit 102, a shape feature value recognition DB 104, a 3DA feature value recognition DB 105, a feature value recognition unit 106, a shape and 3DA feature value correlation DB 107, and a shape and 3DA feature value rule checking unit 108. The design support device 10 uses information such as a design guideline 101, a CAD model 103, and the DBs.

First, the design guideline 101 includes a rule to be considered during design for specifications of a manufacturing device or a tool, a processing limit, and standards such as JIS. For example, the design guideline includes a position definition from an end portion or a bending portion to a hole, a dimensional definition of a fillet R, and accessibility of a manufacturing tool. The determination rule definition unit 102 defines a determination rule to be verified on the CAD model 103. That is, a determination rule used in a rule check executed in the present embodiment is specified. Therefore, the determination rule definition unit 102 provides an interface. The interface includes a user interface for defining an element by referring to or incorporating a rule in the design guideline 101 in accordance with a user operation. Further, the interface includes an interface for defining a determination rule from rules in the design guideline 101 based on user inputs accumulated in the past.

The CAD model 103 includes a CAD model of an object which is a checking target. The object is a design target, and includes not only a product but also components constituting the product. In the present embodiment, a 3D CAD model is used as the CAD model. The shape feature value recognition DB 104 stores a phase feature value and a geometric feature value of an object included in the CAD model 103. Among these, the geometric feature value and the phase feature value applied to a check are recognized by the feature value recognition unit 106 using a function. The 3DA feature value recognition DB 105 stores a 3DA feature value such as an attribute and an annotation defined on the 3D CAD. Then, the feature value recognition unit 106 recognizes a 3DA feature value used in a rule check.

The feature value recognition unit 106 recognizes a 3DA feature value and an example of a shape feature value such as a geometric feature value or a phase feature value and. Then, the feature value recognition unit 106 links these feature values. Specific contents of the linking will be described later. The shape and 3DA feature value correlation DB 107 stores a threshold serving as a basis of determination used in a rule check, and a correlation between the geometric feature value or the phase feature value and the 3DA feature value. Further, the shape and 3DA feature value rule checking unit 108 acquires, from the shape and 3DA feature value correlation DB 107, the correlation between the geometric feature value or the phase feature value and the 3DA feature value that are recognized by the feature value recognition unit 106, and performs a rule check based on the correlation. That is, the shape and 3DA feature value rule checking unit 108 is a rule checking unit that performs a rule check based on the correlation between the shape feature value and the 3DA feature value.

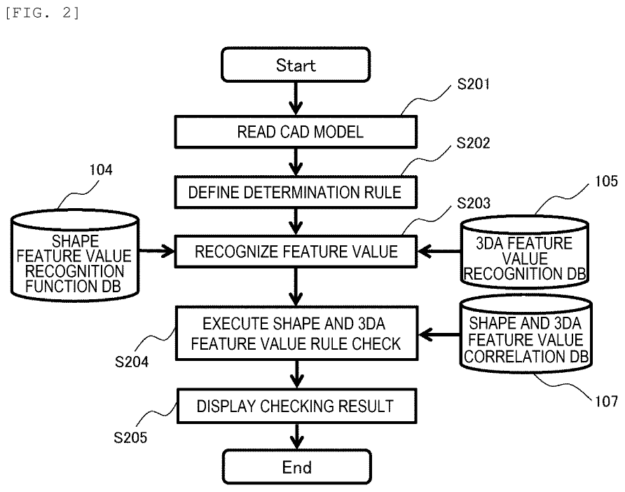

Next, FIG. 2 is a flowchart illustrating rule checking processing in the present embodiment. In this flowchart, the rule checking is started in response to a user operation or the like. First, in step S201, the feature value recognition unit 106 reads the CAD model 103 which is a checking target. In step S202, the determination rule definition unit 102 specifies a determination rule to be subject to rule checking based on the design guideline 101. In step S203, the feature value recognition unit 106 recognizes a shape feature value from the CAD model 103 for the specified determination rule, that is, the determination rule to be checked. In step S203, for example, the phase feature value and the geometric feature value may be recognized. That is, in this step, a positional relationship between feature values can also be recognized by recognizing the phase feature value and the geometric feature value. In this step, the feature value recognition unit 106 recognizes the 3DA feature value with reference to the 3DA feature value recognition DB 105. As described above, in step S203, the feature value recognition unit 106 recognizes the shape feature value and the 3DA feature value. Then, the feature value recognition unit 106 stores these feature values as a data configuration that can be used for a determination check.

In step S204, the shape and 3DA feature value rule checking unit 108 refers to the shape and 3DA feature value correlation DB 107 to acquire a correlation between the shape feature value and the 3DA feature value recognized in step S203. In step S204, the shape and 3DA feature value rule checking unit 108 performs a rule check using the correlation obtained in step S203 and the shape feature value and the 3DA feature value recognized in step S203. Then, in step S205, the shape and 3DA feature value rule checking unit 108 displays a violation location specified by performing the rule check on a display device or the like. The rule checking processing according to the present embodiment has been described above. Next, a mounting example of the design support device 10 according to the present embodiment will be described.

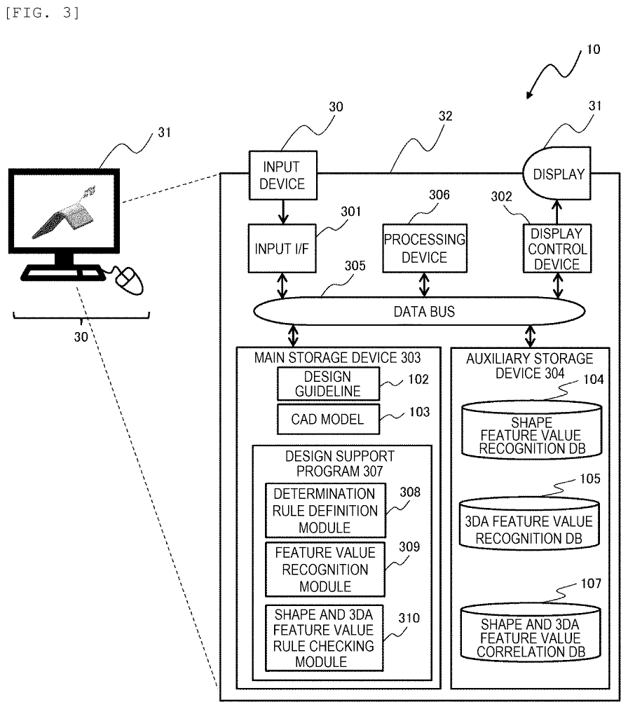

FIG. 3 is a diagram illustrating an example in which the design support device 10 according to the present embodiment is mounted on a computer. The design support device 10 includes an input device 30 and a display 31, which are connected to or integrated with a computer body 32, as illustrated in FIG. 3. Hereinafter, each configuration is described. The input device 30 and the display 31 are examples of an input unit and an output unit that provide an operation environment to a user by a graphic user interface (GUI).

The computer body 32 includes an input interface (hereinafter, input I/F) 301, a display control device 302, a main storage device 303, an auxiliary storage device 304, and a processing device 306, which are connected to one another via a data bus 305. The input I/F 301 receives a user operation input from the input device 30. For example, a determination rule of the CAD model 103 or the design guideline 101 is input. The CAD model 103 or the design guideline 101 may be stored in the auxiliary storage device 304 or the like, and may be acquired from the auxiliary storage device 304 or the like. The display control device 302 controls display on the display 31.

The processing device 306 is a so-called processor and executes various kinds of processing according to programs. The processing device 306 is referred to as a central processing unit (CPU).

The main storage device 303 is also referred to as a memory, and information and programs used for processing in the processing device 306 are loaded into the main storage device 303. That is, the acquired design guideline 101 and CAD model 103 are loaded into the main storage device 303. Further, a design support program 307 is loaded into the main storage device 303 as a program. The design support program 307 includes a determination rule definition module 308, a feature value recognition module 309, and a shape and 3DA feature value rule checking module 310 for each function. Here, the design support program 307 causes the processing device 306 to execute functions of the determination rule definition unit 102, the feature value recognition unit 106, and the shape and 3DA feature value rule checking unit 108 in FIG. 1. That is, functions executed based on modules of the design support program 307 are executed by the respective units in FIG. 1 having the following corresponding relationship. The determination rule definition module 308 corresponds to the determination rule definition unit 102, the feature value recognition module 309 corresponds to the feature value recognition unit 106, the shape and 3DA feature value rule checking module 310 corresponds to the shape and 3DA feature value rule checking unit 108, and these modules may be implemented by an individual program or may be implemented by a program implemented by a combination of some of the modules. The design support program 307 is preferably stored in advance in a storage device or a storage medium such as the auxiliary storage device 304.

The auxiliary storage device 304 stores the shape feature value recognition DB 104, the 3DA feature value recognition DB 105, and the shape and 3DA feature value correlation DB 107. A part or all of hardware included in the computer body 32 may be replaced with a digital signal processor (DSP), a field-programmable gate array (FPGA), a graphics processing unit (GPU), or the like. A part of all of the hardware may be provided in a cloud in a server on a network in a concentrated or distributed manner, and multiple users may perform cooperative work via the network. Such a configuration will be described in Embodiment 3 to be described later. The present embodiment has been described above, and hereinafter, embodiments which are specific aspects will be described.

### Embodiment 1

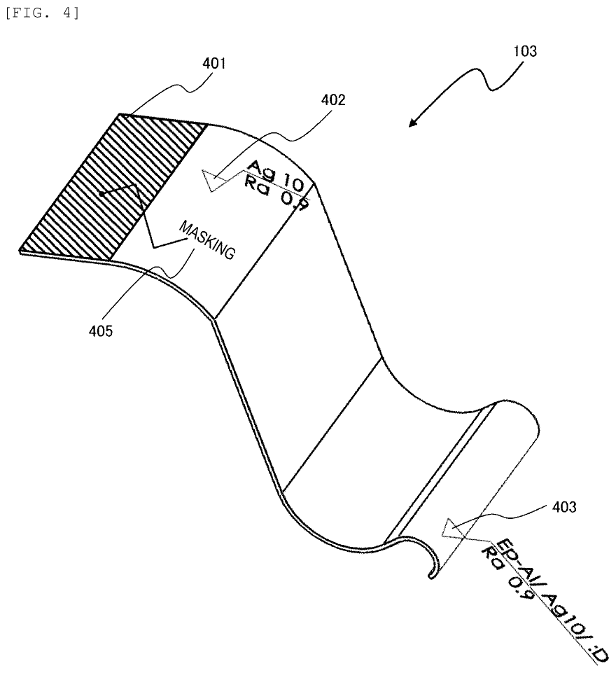

First, an example of a 3DA feature value and a shape feature value according to Embodiment 1 will be described. A configuration in Embodiment 1 is the same as that in FIGS. 1 and 2. This also applies to Embodiment 2 to be described later. FIG. 4 is a diagram illustrating an example of annotations of 3DA feature values in the present embodiment. FIG. 4 is a CAD diagram illustrating the CAD model 103, and annotations are illustrated on the CAD model 103. For example, a masking surface 401 is hatched on the CAD as an instruction not to perform plating. In FIG. 4, a first display example 402 of a silver plating annotation describes a surface property instruction of silver (Ag) plating of 10 μm and surface roughness average of 0.9 μm. As a more detailed example, a second display example 404 of a silver plating annotation can also be used. That is, as illustrated in FIG. 4, the second display example 404 describes electroplating Ep, aluminum (Al) to be plated, silver (Ag) plating of 10 μm, outdoor use (D), and surface average roughness of 0.9 μm. In the present embodiment, plating materials and plating thicknesses, which are 3DA feature values of plating acquired in the first and second display examples, are the same. In an annotation 405 of a masking instruction, instruction contents are displayed on the masking surface 401.

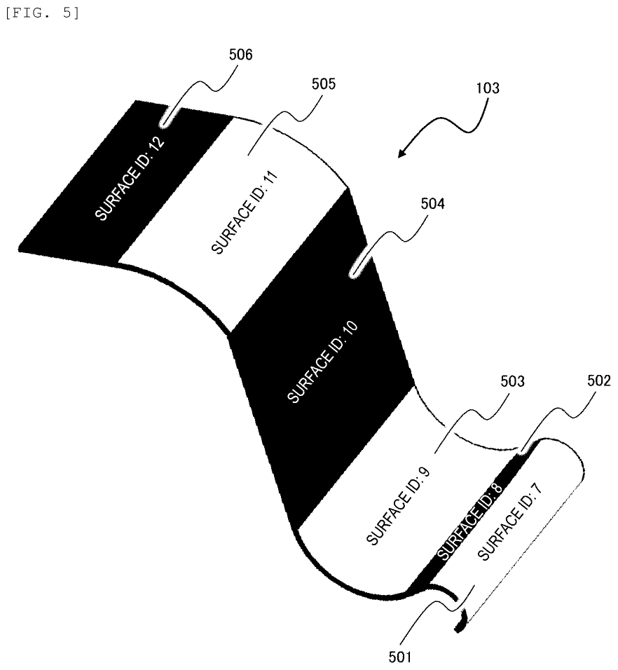

FIG. 5 is a diagram illustrating an example of a curved surface and a flat surface acquired from a curvature among shape feature values in the present embodiment. FIG. 5 illustrates surface IDS of acquired regions and flat surfaces. A unique surface ID is assigned to each surface in FIG. 5. The feature value recognition unit 106 can recognize that a surface ID 7 (501), a surface ID 9 (503), and a surface ID 11 (505) indicate curved surfaces, and a surface ID 8 (502), a surface ID 10 (504), and a surface ID 12 (506) indicate flat surfaces.

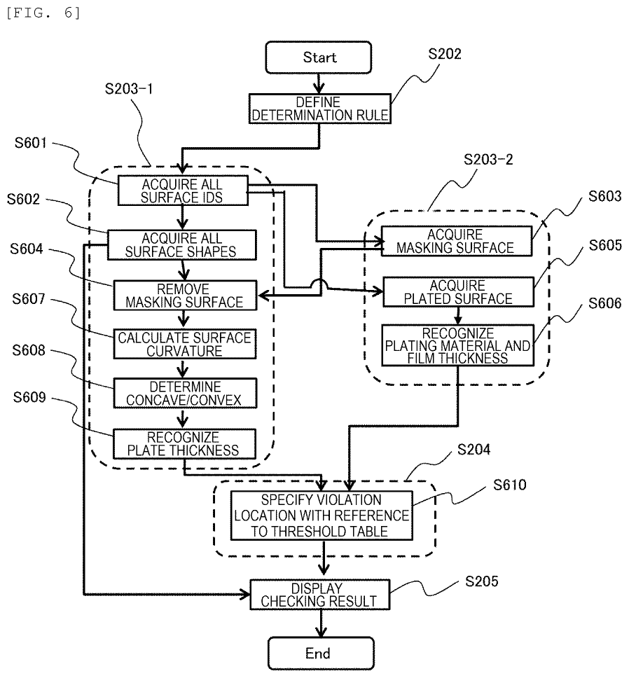

Next, a processing flow according to the present embodiment will be described. FIG. 6 is a flowchart illustrating rule checking processing according to the present embodiment. In this flowchart, steps S203 and S204 in the flowchart in FIG. 2 are described in details. In this flowchart, a peeling checking rule due to bending after plating will be described as an example of a determination rule. First, in step S202, the determination rule definition unit 102 selects a peeling checking rule due to bending after plating based on the design guideline 101.

Steps S203-1 and S203-2 are executed as step S203. In step S203-1, the feature value recognition unit 106 recognizes a shape feature value. More specifically, this is processing of recognizing a geometric feature value that is an example of the shape feature value. Therefore, in step S203-1, steps S601, S602, S604, and S607 to S609 are executed. In step S203-2, a 3DA feature value is recognized. Therefore, in step S203-2, steps S603, S605, and S606 are executed. Hereinafter, details will be described.

First, in step S601, the feature value recognition unit 106 refers to the shape feature value recognition DB 104 to acquire all surface IDs of surfaces constituting an object which is a checking target. Further, in step S602, the feature value recognition unit 106 acquires all surface shapes of the surfaces constituting the object.

In step 603, the feature value recognition unit 106 acquires a masking surface to which plating is not applied from the 3DA feature value recognition DB 105, and associates the masking surface with the surface ID acquired in step S601. In step S604, based on the surface ID, the feature value recognition unit 106 excludes the masking surface acquired in step S603 from surfaces having the surface IDs acquired in step S602. As a result, the masking surface is excluded from the checking target. In step S605, the feature value recognition unit 106 acquires a plated surface from the 3DA feature value recognition DB 204. Here, since a plating instruction is described only for a representative surface, all surfaces other than the masking surface are regarded as being subject to plating processing under the same condition. In step S606, the feature value recognition unit 106 recognizes a plating material (here, Ag) and a film thickness (9 μm) which are 3DA feature values from the 3DA feature value recognition DB 105. As described above, in step S203-2, the plating material and the film thickness of each surface are recognized as the 3DA feature value using a function stored in the 3DA feature value recognition DB 105.

In step S607, the feature value recognition unit 106 refers to the shape feature value recognition DB 104 to calculate a surface curvature for a surface other than the excluded masking surface. Thereafter, in step S608, the feature value recognition unit 106 determines whether each surface is a concave or convex surface based on the surface curvature calculated in step S607. Then, in step S609, the feature value recognition unit 106 recognizes a plate thickness. As described above, in step S203-1, a curvature, a curvature radius, a plate thickness, and a concave or convex surface of each surface are recognized as the shape feature values using a function stored in the shape feature value recognition DB 104.

Next, step S610 is executed as the rule check in step S204 in FIG. 2. In step S610, the shape and 3DA feature value rule checking unit 108 specifies a violation location with reference to a threshold table stored in the shape and 3DA feature value correlation DB 107 based on the recognized plate thickness which is the shape feature value and the plating material and the film thickness which are the 3DA feature values. In step S205, the shape and 3DA feature value rule checking unit 108 highlights the rule violation location specified in step S610. For example, the display control device 302 illustrated in FIG. 3 displays the rule violation location on the display 31. FIG. 6 has been described above.

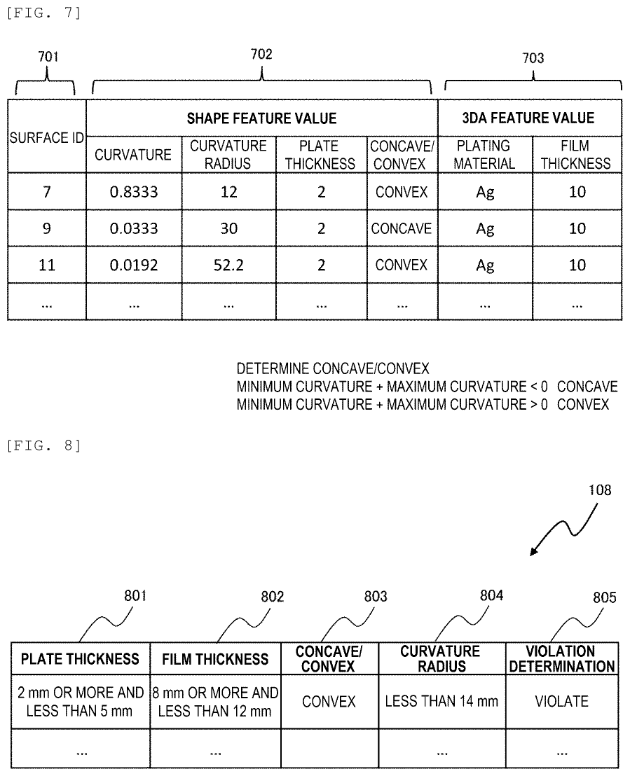

Next, information used in the present embodiment will be described with reference to FIGS. 7 and 8. FIG. 7 is a diagram illustrating a shape feature value 702 and a 3DA feature value 703 for each surface ID 701 acquired in the present embodiment. FIG. 7 illustrates a result in which the feature value recognition unit 106 links, that is, associates the shape feature value 702 and the 3DA feature value 703 recognized in steps S203-1 and S203-2. The surface ID 701 in FIG. 7 is a unique ID assigned to a surface of an object on the CAD model 103. The shape feature value 702 includes items of a curvature, a curvature radius, a plate thickness, and concave/convex acquired using a function stored in the shape feature value recognition DB 104. The 3DA feature value 703 includes items of a plating material and a film thickness acquired using a function stored in the 3DA feature value recognition DB unit 105. Here, the surface ID is acquired in step S601 in FIG. 6. The items of the shape feature value 702 are acquired as follows. First, the curvature and the curvature radius are recognized in step S607, and the plate thickness is recognized in step S609. Further, the concave/convex is recognized in step S608. Further, the plating material and the film thickness s of the 3DA feature value 703 are recognized in step S606.

Next, FIG. 8 is a diagram illustrating the shape and 3DA feature value correlation DB 107 in the present embodiment. As illustrated in FIG. 8, the shape and 3DA feature value correlation DB 107 includes items of a plate thickness 801, a film thickness 802, concave/convex 803, a curvature radius 804, and violation determination 805. First, the plate thickness 801 indicates a range of plate thicknesses which indicates a violation in a rule check. The film thickness 802 indicates a range of film thicknesses of plating which indicates a violation in a rule check. The concave/convex 803 indicates violation when a corresponding surface is convex in a rule check. The curvature radius 804 indicates a threshold of a curvature radius which indicates a violation in a rule check. Here, when a condition in which the plate thickness 801 and the film thickness 802 are within specified ranges, the concave/convex 803 is convex, and a threshold of the curvature radius 804 is less than 14 mm is satisfied, the shape and 3DA feature value rule checking unit 108 determines that a corresponding surface is a violation.

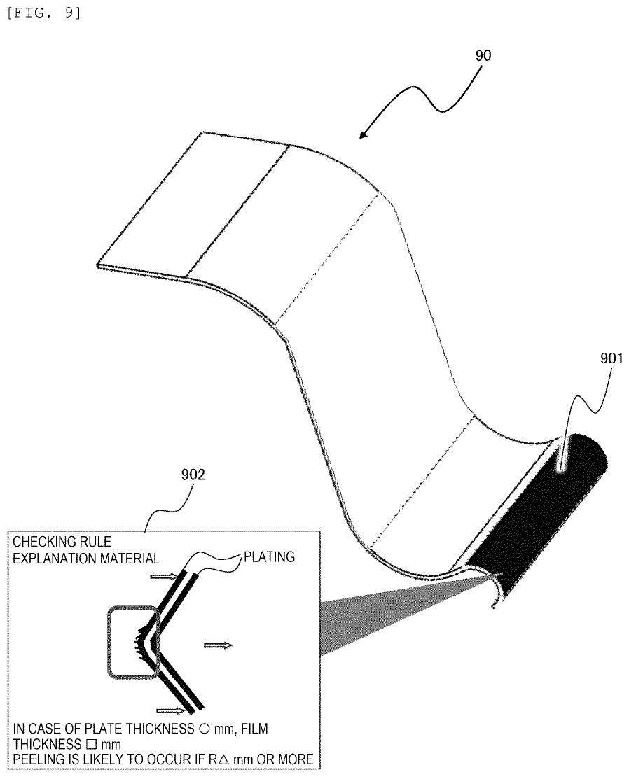

Next, a checking result displayed in step S205 will be described. FIG. 9 is a CAD diagram illustrating a checking result 90 in the present embodiment. In FIG. 9, a violation location 901 is highlighted as a surface where plating peeling is likely to occur. That is, in step S205, the CAD diagram illustrated in FIG. 9 is displayed on the display 31. This makes it possible to issue an alert indicating the determination rule defined in step S202 is violated. In step S205, a checking rule explanation material 902 may be displayed on the display 31. The checking rule explanation material 902 includes contents of a checking rule, a threshold to be corrected, and precautions, and can make a user be aware of a problem. Both the checking result 90 and the checking rule explanation material 902 may be displayed on the display 31, or one of them may be displayed. Further, the checking result 90 and the checking rule explanation material 902 may be selectively displayed. Embodiment 1 has been described above.

### Embodiment 2

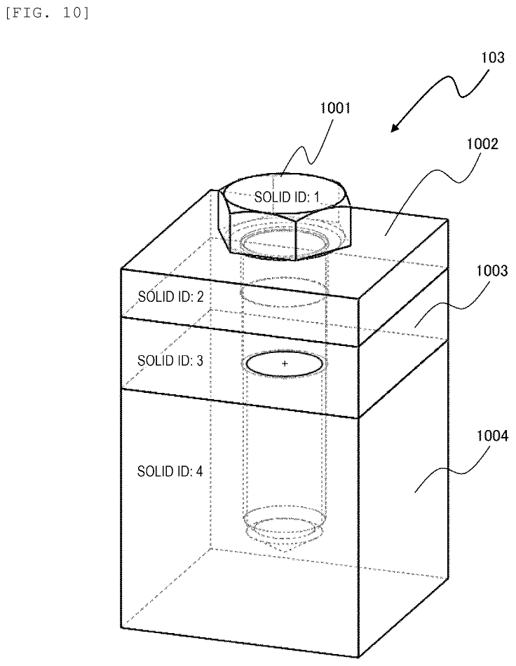

In Embodiment 2, a hole diameter and a length of a bolt insertion hole are used as a shape feature value, and a bolt attribute is used as a 3DA feature value to perform a rule check related to the bolt hole diameter and the bolt length. In the present embodiment, at least one of a rule check related to the bolt hole diameter and a rule check related to the bolt length may be executed. FIG. 10 is a diagram illustrating the CAD model 103 which is a checking target in the present embodiment. FIG. 10 illustrates a bolt 1001 having a solid ID 1 and components 1002 to 1004 into which the bolt is inserted. Here, in Embodiment 2, management is performed by a solid (unit solid) instead of a surface of each component. That is, a unique ID assigned to each solid is utilized. Specifically, unique IDs of solids are set such that the bolt 1001 has a solid ID 1, the component 1002 has a solid ID 2, the component 1003 has a solid ID 3, and the component 1004 has a solid ID 4.

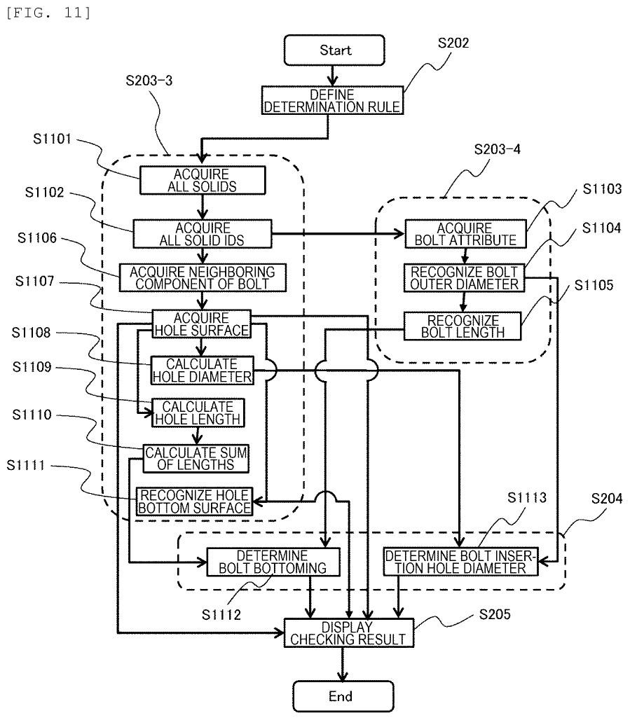

Next, a processing flow according to the present embodiment will be described. FIG. 11 is a flowchart illustrating rule checking processing according to the present embodiment. In this flowchart, steps S203 and S204 in the flowchart in FIG. 2 are described in details as in Embodiment 1. First, in step S202, the determination rule definition unit 102 selects a determination rule to be executed based on the design guideline 101. Here, the determination rule definition unit 102 selects a rule for checking consistency between a bolt and a hole.

Steps S203-3 and S203-4 are executed as step S203. In step S203-3, the feature value recognition unit 106 recognizes a shape feature value. More specifically, this is processing of recognizing a geometric feature value that is an example of the shape feature value. Therefore, in step S203-3, steps S1101, S1102, and S1106 to S1111 are executed. In step S203-4, a bolt attribute that is a 3DA feature value is recognized. Therefore, in step S203-4, steps S1103 to S1105 are executed. Hereinafter, details will be described.

First, in step S1101, the feature value recognition unit 106 acquires all solids constituting an object which is a checking target. In step S1102, the feature value recognition unit 106 acquires solid IDs for identifying the acquired solids using a function of the shape feature value recognition DB 104.

In step S1103, the feature value recognition unit 106 specifies a bolt based on annotation information of the bolt in the acquired solids using a function of the 3DA feature value recognition DB 105, and recognizes a bolt attribute indicating an attribute. In the present embodiment, it is assumed that the bolt 1001 having the solid ID 1 in FIG. 10 is specified. In step S1104, the feature value recognition unit 106 recognizes an outer diameter of the specified bolt 1001. In step S1105, the feature value recognition unit 106 recognizes a length of the specified bolt 1001. As a result, in step S203-4, the feature value recognition unit 106 recognizes the outer diameter and the length of the bolt 1001 which is an example of a solid as the bolt attribute which is a 3DA feature value. As described above, it is desirable to use, as the bolt attribute which is the 3DA feature value, a feature value related to connection with a component in the neighbor of the bolt.

In step S1106, the feature value recognition unit 106 specifies a component (neighboring component) in the neighbor of the bolt 1001 specified in step S1103 using a function of the shape feature value recognition DB 104. In the example of FIG. 10, the components 1002 to 1004 having the solid IDs 2 to 4, which are combined with the bolt 1001, are specified. That is, a plurality of neighboring components are specified. In step S1107, the feature value recognition unit 106 specifies a related portion related to the bolt 1001 in the specified neighboring components (components 1002 to 1004). The related portion indicates, for example, a portion connected to the bolt 1001. In the present embodiment, an insertion hole (hole surface) into which the bolt 1001 is inserted is specified as the related portion.

In step S1108, the feature value recognition unit 106 specifies, from the shape feature value recognition DB 104, a hole diameter of the insertion hole of each of the components 1002 to 1004 which are the specified neighboring components. In step S1109, the feature value recognition unit 106 calculates a length of each of the specified insertion holes. Then, in step S1110, the feature value recognition unit 106 obtains the sum of the lengths of the insertion holes of the components 1002 to 1004.

On the other hand, in step S1111, the feature value recognition unit 106 recognizes a hole bottom surface from a hole surface (insertion hole) acquired in step S1107. As described above, step S203-3 is executed. As a result, the feature value recognition unit 106 recognizes the hole diameters and the lengths of the insertion holes of the components 1002 to 1004 and the sum of the lengths of the insertion holes as shape feature values.

Next, steps S1112 and S1113 are executed as the rule check in step S204 in FIG. 2. First, in step S1112, a rule check is performed, and a bolt bottoming determination is executed. Therefore, the shape and 3DA feature value rule checking unit 108 compares a length of the bolt 1001 and the sum of the lengths of the insertion holes of the components 1002 to 1004 using the shape and 3DA feature value correlation DB 107, and executes the rule check. For example, when the sum of the lengths of the insertion holes is shorter than the length of the bolt 1001, the shape and 3DA feature value rule checking unit 108 determines a violation indicating that the bolt is on a bottom surface. A checking result is displayed in step S205. In the above example, the shape and 3DA feature value rule checking unit 108 highlights that a hole bottom surface acquired in step S1111 as a violation location.

On the other hand, in step S1113, the shape and 3DA feature value rule checking unit 108 compares the hole diameter of the insertion hole acquired in step S1108 with a bolt outer diameter recognized in step S1104 using the shape and 3DA feature value correlation DB 107, and executes the rule check. For example, when the bolt insertion hole is smaller than the bolt outer diameter, the shape and 3DA feature value rule checking unit 108 determines that it is difficult to insert the bolt 1001. A checking result is displayed in step S205. In the above example, the shape and 3DA feature value rule checking unit 108 highlights a hole shape as a violation location.

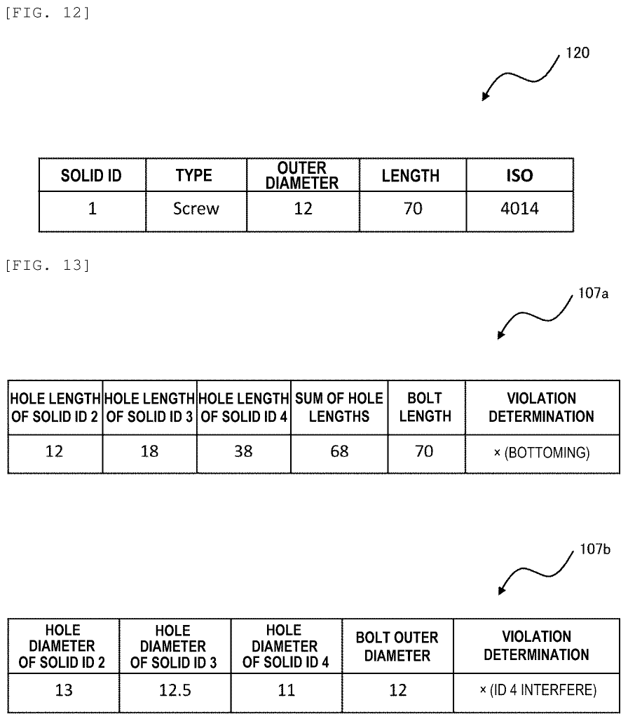

Here, a 3DA feature value used in the present embodiment will be described. FIG. 12 is a diagram illustrating a 3DA feature value 120 of a bolt in the present embodiment. FIG. 12 illustrates an example of the 3DA feature value in the 3DA feature value recognition DB 105 for an attribute of the bolt 1001. That is, the 3DA feature value 120 includes items of a type, an outer diameter, a length, and ISO for each solid ID. Here, for a target shape of a solid ID 1, information includes a type of screw which refers to a bolt, an outer diameter of 12 mm, a length of 70 mm, and ISO 4014 which is a standard to conform to.

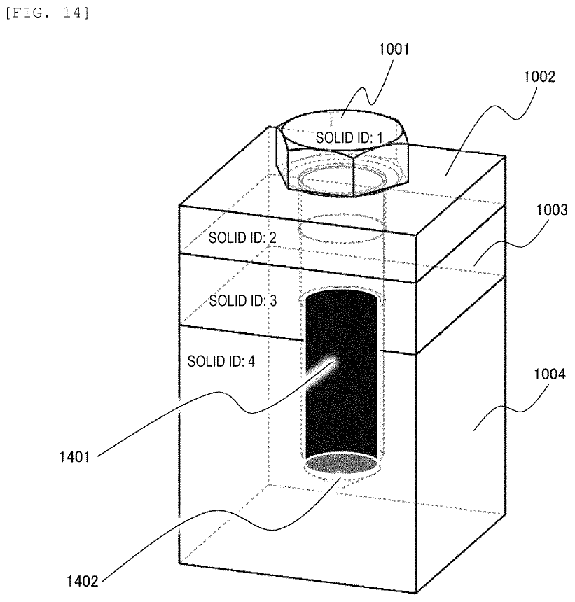

Next, FIG. 13 is a diagram illustrating the shape and 3DA feature value correlation DB 107 in the present embodiment. The shape and 3DA feature value correlation DB 107 in FIG. 13 illustrates an example of a data configuration applied to determination in the shape and 3DA feature value rule checking unit 108. In the present embodiment, shape and 3DA feature value correlation DBs 107a and 107b are used. In the shape and 3DA feature value correlation DBs 107a and 107b, items indicating shape feature values and 3DA feature values are associated with each other, and violation determination is recorded. That is, FIG. 13 illustrates a result in which the feature value recognition unit 106 links, that is, associates the shape feature values and the 3DA feature values recognized in steps S203-3 and S203-4.

First, the shape and 3DA feature value correlation DB 107a is used in step S1112 and includes items of a hole length of a solid ID 2, a hole length of a solid ID 3, a hole length of a solid ID 4, a hole length sum, a bolt length, and violation determination. The hole length of the solid ID 2, the hole length of the solid ID 3, the hole length of the solid ID 4, and the hole length sum are the shape feature values acquired in steps S1109 and S1110. The bolt length is the 3DA feature value recognized in step S1105. The violation determination indicates the checking result determined in step S1112. Here, a bolt length 1105 is 70 mm while the hole length sum is 68 mm, a violation is recorded in the violation determination due to the occurrence of bottoming.

On the other hand, the shape and 3DA feature value correlation DB 107b is used in step S1113 and includes items of a hole diameter of the solid ID 2, a hole diameter of the solid ID 3, a hole diameter of the solid ID 4, a bolt outer diameter, and violation determination. Here, the hole diameter of the solid ID 2, the hole diameter of the solid ID 3, and the hole diameter of the solid ID 4 are the shape feature values acquired in step S1108. The bolt outer diameter is the 3DA feature value recognized in step S1104. The violation determination indicates the checking result determined in step S1113. Here, in the bolt insertion hole determination in step S1113, the bolt outer diameters acquired in step S1108 and step S1104 are compared. As a result, the hole diameter of the solid ID 4 is 11 mm while the bolt outer diameter is 12 mm, which causes interference. Therefore, a result of violation determination 1302 for the hole diameter of the bolt is a violation.

As described above, in the shape and 3DA feature value correlation DB 107, specifically, a geometric feature value which is a related shape feature value and a 3DA feature value are associated with each other for a target component of the bolt 1001 and a neighboring component of the target component. In the present embodiment, a result of the violation determination performed based on the association relationship is also recorded.

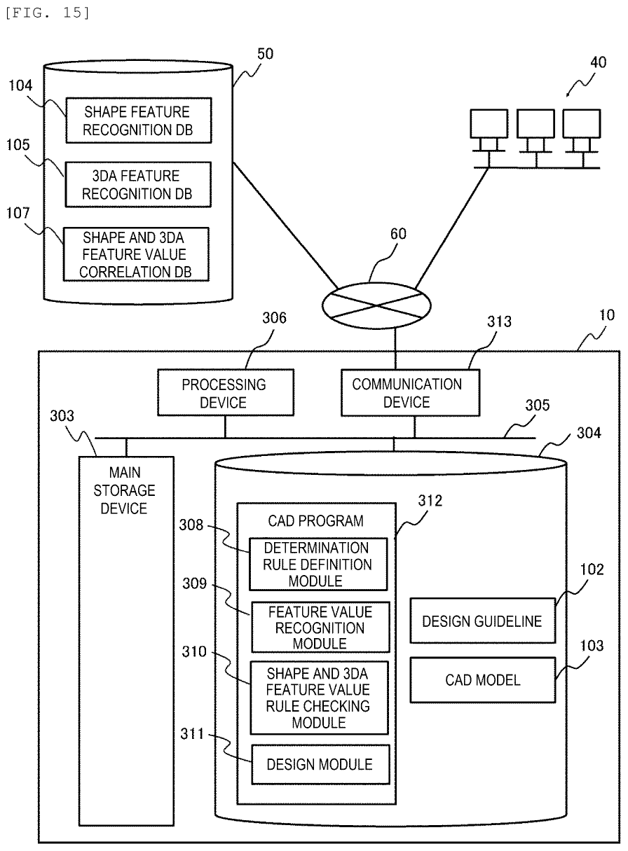

Next, the checking result displayed in step S205 in the present embodiment will be described. FIG. 14 is a CAD diagram illustrating a checking result in the present embodiment. Contents of FIG. 14 are displayed on the display 31. In FIG. 14, a result 1401 of violation determination of a bolt hole diameter check and a result 1402 of violation determination at a bolt bottom are highlighted. Although colors are output separately corresponding to each rule in the example, a display method is not limited thereto. Embodiment 2 has been described above.

### Embodiment 3

The Embodiment 3 is an embodiment in which the design support device 10 is implemented as a so-called cloud system. FIG. 15 is a system configuration diagram according to Embodiment 3. In FIG. 15, the design support device 10 is connected to a terminal device group 40 and a database system 50 via a network 60. The design support device 10 can be implemented by a computer such as a so-called server. The design support device 10 implements the design support function according to Embodiment 1 or 2 as a part of a design function. A configuration of the design support device 10 will be described below.

In the design support device 10 according to the present embodiment, the processing device 306, a communication device 313, the main storage device 303, and the auxiliary storage device 304 are connected to one another via the data bus 305. The processing device 306, the main storage device 303, the auxiliary storage device 304, and the data bus 305 have the same functions as those in FIG. 3.

However, the auxiliary storage device 304 stores a CAD program 312 that implements a design function instead of the design support program 307. The CAD program 312 is loaded into the main storage device 303, and processing according to the program is executed by the processing device.

The CAD program 312 includes a design module 311 for performing design in addition to the determination rule definition module 308, the feature value recognition module 309, and the shape and 3DA feature value rule checking module 310 in FIG. 3. The CAD model 103 is created according to the design module 311. Each of the modules may be executed by an individual program. In particular, the design module 311 may be implemented as an independent program, or as a program separate from the design support program.

Further, in the present embodiment, the design guideline 101 and the CAD model 103 are stored in the auxiliary storage device 304. The shape feature value recognition DB 104, the 3DA feature value recognition DB 105, and the shape and 3DA feature value correlation DB 107 are stored in the database system 50. However, these are merely examples, and information or a DB may be stored in another device.

The communication device 313 is connected to the terminal device group 40 and the database system 50 via the network 60. The terminal device group 40 is a computer used by a user, and includes the input device 30, the input I/F 301, the display 31, and the display control device 302 in FIG. 3, or has functions similar to these devices. As a result, the terminal device group 40 receives a user operation and displays a checking result.

The embodiments of the invention have been described above, but the invention is not limited thereto. For example, a CAD model other than the 3D model can be used. Further, the object is not limited to a product, a component, or the like.

### REFERENCE SIGNS LIST

10: design support device
101: design guideline
102: determination rule definition unit
103: CAD model
104: shape feature value recognition DB
105: 3DA feature value recognition DB
106: feature value recognition unit
107: shape and 3DA feature value correlation DB
108: shape and 3DA feature value rule checking unit
30: input device
31: display
301: input I/F
302: display control device
303: main storage device
304: auxiliary storage device
305: data bus
306: processing device
307: design support program
308: determination rule definition module
309: feature value recognition module
310: shape and 3DA feature value rule checking module
311: design module
312: CAD program
313: communication device
40: terminal device group
50: database system
60: network

1. A design support device that executes a rule check using a determination rule on a CAD model of an object which is a design target, the design support device comprising:
a feature value recognition unit configured to recognize a 3DA feature value defined on the CAD model and a shape feature value related to a shape of the object, the 3DA feature value and the shape feature value being related information of the object; and
a rule checking unit configured to execute the rule check based on a correlation between the 3DA feature value and the shape feature value.

2. The design support device according to claim 1, wherein
the 3DA feature value includes at least one of an annotation and an attribute.

3. The design support device according to claim 1, wherein
the feature value recognition unit associates the shape feature value of a corresponding component with the 3DA feature value, and the rule checking unit executes the rule check by comparing the associated shape feature value with the 3DA feature value.

4. The design support device according to claim 3, wherein
the 3DA feature value includes a plating material of the object and a film thickness of the plating material.

5. The design support device according to claim 1, wherein
the feature value recognition unit associates a 3DA feature value of a corresponding component with a shape feature value of a neighboring component in the neighbor of the component, and
the rule checking unit executes the rule check by comparing the associated 3DA feature value of the component with the shape feature value of the neighboring component.

6. The design support device according to claim 5, wherein
the 3DA feature value is a bolt attribute, and
the rule checking unit executes the rule check by comparing a bolt length obtained based on the bolt attribute with a sum of lengths of insertion holes of a plurality of the neighboring components.

7. The design support device according to claim 1 wherein
the shape feature value includes a geometric feature value and a phase feature value,
the geometric feature value indicates a geometric feature including an area, a length, and an angle of the object, and
the phase feature value indicates a phase related to a connection relationship with the object.

8. The design support device according to claim 1, wherein
the feature value recognition unit recognizes the shape feature value and the 3DA feature value for each portion constituting the object.

9. The design support device according to claim 8, wherein
the portion is a surface or a unit solid of the object.

10. A design support program for causing a design support device, which is a computer that executes a rule check using a determination rule on a CAD model of an object which is a design target, to function as:
a feature recognition unit configured to recognize a 3DA feature value defined on the CAD model and a shape feature value indicating a feature related to a shape of the object, the 3DA feature value and the shape feature value being related information of the object; and
a rule checking unit configured to execute the rule check based on a correlation between the 3DA feature value and the shape feature value.

11. The design support program according to claim 10, wherein
the 3DA feature value includes at least one of an annotation and an attribute.

12. The design support program according to claim 10, wherein
the feature value recognition unit associates the shape feature value of a corresponding component with the 3DA feature value, and
the rule checking unit executes the rule check by comparing the associated shape feature value with the 3DA feature value.

13. A design support method using a design support device that executes a rule check using a determination rule on a CAD model of an object which is a design target, the design support method comprising:
recognizing, by a feature value recognition unit, a 3DA feature value defined on the CAD model and a shape feature value indicating a feature related to a shape of the object, the 3DA feature value and the shape feature value being related information of the object; and
executing, by the rule checking unit, the rule check based on a correlation between the 3DA feature value and the shape feature value.

14. The design support method according to claim 13, wherein
the 3DA feature value includes at least one of an annotation and an attribute.

15. The design support method according to claim 13, wherein
the feature value recognition unit associates the shape feature value of a corresponding component with the 3DA feature value, and
the rule checking unit executes the rule check by comparing the associated shape feature value with the 3DA feature value.
